(19) United States
(12) Patent Application Publication
(10) Pub. No.: US 2015/0002404 A1
(43) Pub. Date: Jan. 1, 2015

(54) CUSTOMIZABLE STEERING WHEEL CONTROLS

(71) Applicant: GM GLOBAL TECHNOLOGY OPERATIONS LLC, Detroit, MI (US)

(72) Inventor: Joel S. Hooton, Chesterfield, MI (US)

(21) Appl. No.: 13/928,749

(22) Filed: Jun. 27, 2013

(51) Int. Cl. B60R 16/02; G06F 3/02; G06F 3/041; B62D 1/04

(52) U.S. Cl. CPC B60R 16/02; B62D 1/04; G06F 3/02; G06F 3/0416
USPC 345/173; 345/156; 345/184

(57) ABSTRACT

A steering wheel comprises a control interface coupled to a device controller. The device controller is configured for controlling operation of at least one vehicle device, and the at least one vehicle device comprises an active device. The at least one control interface comprises a display element for visually displaying an interface image associated with the active device. The device controller comprises a processor coupled to a memory storage device and is configured for communicating the interface image to the at least one control interface for display by the display element. The at least one control interface is configured for receiving an operator input and transmitting an input signal indicative of the operator input to the device controller. The device controller configured for receiving the input signal from the at least one control interface and for transmitting a control signal to the active device in accordance with the input signal.

### FIELD OF THE INVENTION

The subject invention relates to control elements for mounting on a steering wheel and more particularly to a steering wheel including a plurality of control elements with each control element including an operator-configurable display element.

### BACKGROUND

In today's world, automobiles are incorporating an ever-increasing array of features and controls to enhance the safety and convenience of the driving experience. As a result, vehicle designers are confronted with the challenge of providing operators with the ability to control the proliferation of devices without over-complicating or cluttering the operator's space. One common solution has been to place some controls on the steering wheel in addition to their more-traditional placement on the dashboard or the console or the door. Unfortunately, however, the available space on the steering wheel tends to limit the quantity of control elements that may be placed on the steering wheel. In addition, operators may tend to disagree on what control functions they may prefer to operate via a control element mounted on the steering wheel. Moreover, traditional steering-wheel-mounted control elements lack the ability to be customized by the operator.

Accordingly, it is desirable to provide a steering wheel with operator-configurable control elements, particularly where each control element includes an operator-configurable display element.

### SUMMARY OF THE INVENTION

In an exemplary embodiment of the invention, a steering wheel for a vehicle comprises at least one control interface coupled to a device controller. The device controller is configured for controlling operation of at least one vehicle device, and the at least one vehicle device comprises an active device. The at least one control interface comprises a display element for visually displaying an interface image associated with the active device. The device controller comprises a processor coupled to a memory storage device and is configured for communicating the interface image to the at least one control interface for display by the display element. The at least one control interface is configured for receiving an operator input and transmitting an input signal indicative of the operator input to the device controller. The device controller configured for receiving the input signal from the at least one control interface and for transmitting a control signal to the active device in accordance with the input signal.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic drawing showing an exemplary system for providing operator-configurable control elements on a steering wheel; and

FIG. 2 is a drawing showing an exemplary steering wheel including a plurality of operator-configurable control elements.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, FIG. 2 is a drawing showing an exemplary steering wheel 100 including a plurality of operator-configurable control elements 102. As shown in FIG. 2, a steering wheel 100 for a vehicle (not shown) comprises at least one control element 102, each comprising a control interface 104 for displaying information 106 to an operator and for receiving control inputs 108 from the operator.

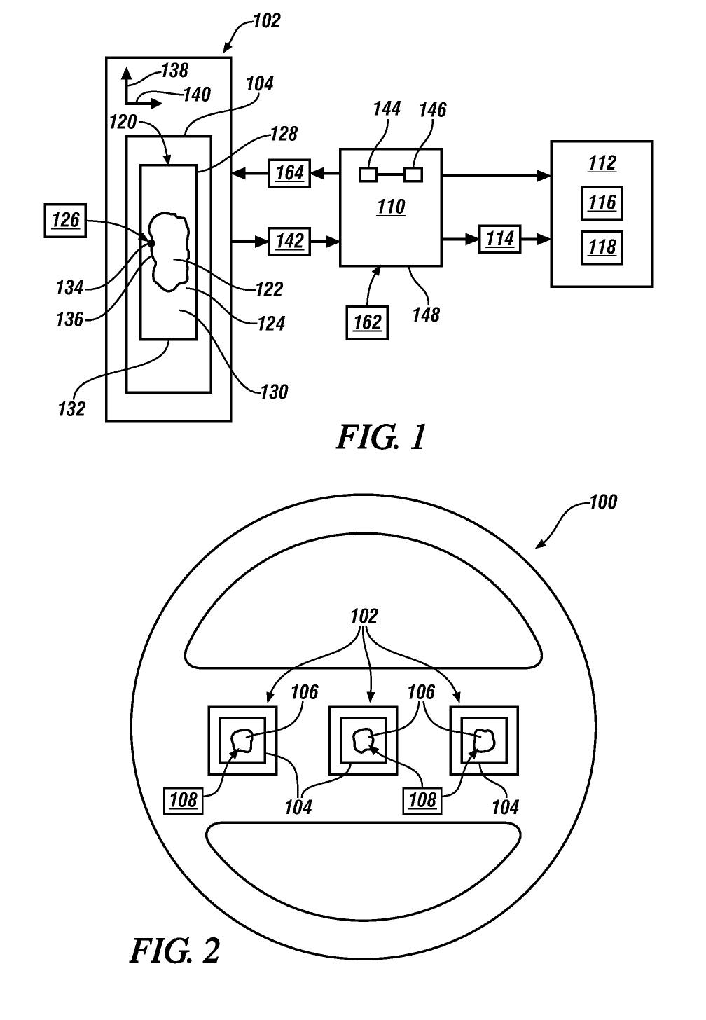

In accordance with an exemplary embodiment of the invention, FIG. 1 is a schematic drawing showing an exemplary system for providing operator-configurable control elements 102 on a steering wheel 100. As shown in FIG. 1, each control element 102, and thus each control interface 104, is coupled to a device controller 110. The device controller 110 is configured for controlling operation of at least one vehicle device 112. Where the device controller 110 is configured for controlling operation of more than one device 112, it may be necessary or advantageous for some of those vehicle devices 112 to be active while others of those vehicle devices 112 are inactive at a given time. This means that control signals 114 dispatched by the device controller 110 are for use by the active device 116 and are to be ignored by inactive devices 118. Therefore, for purposes of this disclosure, vehicle devices 112 will be classified as active devices 116 and inactive devices 118, and the set of at least one vehicle devices 112 comprises an active device 116.

In an exemplary embodiment, the control element 102 comprises a control interface 104, which comprises a display element 120 for visually displaying an interface image 122 associated with the active device 116. The display element 120 may comprise an organic light emitting diode 124 or another means for displaying visual information, such as the interface image 122, to the operator suitable for indicating to the operator what control function is associated with actuation of the control element 102 and for providing feedback to the operator (e.g., whether, how, and to what extent operator inputs 126 have been or may be received by the control element 102). For example, where the control element 102 is to be configured for operating a volume control, a range of volume positions may be visually provided to provide visual feedback indicating where the volume is currently set and what range of adjustment remains available—similar to feedback that might be provided by a conventional analog knob or slider. In an exemplary embodiment, a cover 128 may be disposed over the display element 120. The cover 128 may be flexible. In addition, the cover 128 may be translucent or transparent (i.e., clear).

In an exemplary embodiment, the control interface 104 comprises a pressure sensitive switch element 130. The control interface 104 may comprise a touch-sensitive screen 132 that is configured for detecting a position 134 of a touch input 136 in at least one direction 138. The touch-sensitive screen 132 may also be configured for detecting the position 134 of the touch input 136 in two dimensions 138, 140 and for detecting movement of the touch along one or both dimensions 138, 140. Each control interface 104 is configured for receiving an operator input 126 and transmitting an input signal 142 indicative of the operator input 126 to the device controller 110.

In an exemplary embodiment, the device controller 110 comprises a processor 144 coupled to a memory storage device 146. In one embodiment, the device controller 110 is a vehicle body controller 148. In other embodiments, the device controller 110 or aspects of the device controller 110 may be distributed about the vehicle, for example, integrated with the devices under control. The device controller 110 is configured for receiving information 162 from an operator indicative of an operator request to activate a particular vehicle device 112 and to configure the control interface 104 for inputs facilitating control over the active device 116.

In an exemplary embodiment, the device controller 110 is configured for communicating information 164 to the control interface 104 sufficient to define the interface image 122 for display by the display element 120. The interface image 122 may be indicative of a control function facilitated by the control interface 104. The interface images associated with each vehicle device 112 is stored in the memory storage device 146, and is retrieved from memory storage device 146 by the processor 144 when a vehicle device 112 is activated. The interface image 122 is formed to represent the active device 116 together with any operator preferences that may be associated with the active device 116 and accordingly stored in the memory storage device 146.

In an exemplary embodiment, the control interface 104 is configured for receiving an operator input 126 and transmitting an input signal 142 indicative of the operator input 126 to the device controller 110. In an exemplary embodiment, the device controller 110 is configured for receiving the input signal 142 from the control interface 104 and for transmitting a control signal 114 to the active device 116 in accordance with the input signal 142.

The vehicle device 112 may comprise an element of a vehicle entertainment system. Accordingly, the control function may comprise adjusting volume, tone (bass/treble), sound equalization (relative amplification of various frequencies/frequency ranges) of a vehicle entertainment system, or volume of individual speakers or sets of speakers (i.e., balance/fade) of a vehicle entertainment system.

The vehicle device 112 may comprise an element of an environmental control system. Accordingly, the control function may comprise adjusting temperature settings, blower/fan settings, or operating modes (max a/c, heater, vent, defrost, bi-level, floor, side window, rear zone, etc.) of an environmental control system. The vehicle device 112 may comprise a vehicle speed control. Accordingly, the control function may comprise activating and/or adjusting settings (e.g., cruise, coast, resume, set speed, etc.) of a vehicle speed control system.

The vehicle device 112 may comprise a vehicle aperture such as a window or a door or a deck lid. Accordingly, the control function may comprise opening or closing or locking or unlocking the window or the door or the deck lid. The control function may further comprise adjusting a desired setting (closed, barely open, partially open, mostly open, fully open, etc.) of the vehicle aperture. The vehicle device 112 may comprise a vehicle lighting system. Accordingly, the control function may comprise adjusting a lighting level of a vehicle lighting system.

The vehicle device 112 may comprise a communication interface. Accordingly, the control function may comprise activating or operating the communication interface. For example, the control function may comprise accessing or displaying contact information from a portable communication device or a navigation system, displaying messages (e.g., text messages, directions) from the portable communication device or navigation system, initiating or answering a call via a portable communication device or storing information on a portable communication device or seeking directions or maps associated with a specified geographic location.

As a result, a steering wheel 100 may be provided with operator-configurable control elements 102, particularly where each control element 102 including an operator-configurable display element 120. Accordingly, a number of advantages may be realized including reductions in time spent and compromises made studying, determining and implementing packaging controls on the steering wheel 100. In addition, operator frustration with wheel button icons and with button placement or lack of button features may be reduced. In accordance with exemplary embodiments, a steering wheel 100 may be provided with controls that change for the operator, by the operator. Further, by adapting OLED technologies for use on steering wheel 100 controls, operator configurability may be facilitated.

In one exemplary embodiment, each control element 102 may have a dedicated OLED screen under a clear cover 128. Thus, steering wheel 100 controls may be configured based on the content or control features of the particular vehicle in which the steering wheel 100 is to be installed without requiring a dedicated part for the particular vehicle. This leads to commonality in designs—regardless of vehicle content. In addition, operators may be enabled to customize their own features and arrangements, enabling them to individualize the feel of their operator experience. Still further, upgrades to control features may be facilitated via upgrades to software that is saved in the memory storage device 146 and that is effective to control the logic implemented by the processor 144 of the device controller 110.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A steering wheel for a vehicle comprising:
at least one control interface coupled to a device controller, the device controller being configured for controlling operation of at least one vehicle device, the at least one vehicle device comprising an active device;
the at least one control interface comprising a display element for visually displaying an interface image associated with the active device;
the device controller comprising a processor coupled to a memory storage device;
the device controller configured for communicating the interface image to the at least one control interface for display by the display element;
the at least one control interface configured for receiving an operator input and transmitting an input signal indicative of the operator input to the device controller;
the device controller configured for receiving the input signal from the at least one control interface and for transmitting a control signal to the active device in accordance with the input signal.

2. The steering wheel of claim 1, wherein the display element comprises an organic light emitting diode.

3. The steering wheel of claim 1, further comprising a cover disposed over the display element.

4. The steering wheel of claim 3, wherein the cover is flexible.

5. The steering wheel of claim 3, wherein the cover is translucent.

6. The steering wheel of claim 3, wherein the cover is transparent.

7. The steering wheel of claim 1, wherein the at least one control interface comprises a pressure sensitive switch element.

8. The steering wheel of claim 1, wherein the at least one control interface comprises a touch-sensitive screen configured for detecting a location of a touch input in at least one direction.

9. The steering wheel of claim 8, wherein the touch-sensitive screen is configured for detecting the location of the touch input in two dimensions.

10. The steering wheel of claim 1, wherein the device controller is a vehicle body controller.

11. The steering wheel of claim 1, wherein the active device comprises an element of a vehicle entertainment system.

12. The steering wheel of claim 1, wherein the active device comprises an element of an environmental control system.

13. The steering wheel of claim 1, wherein the active device comprises a vehicle speed control.

14. The steering wheel of claim 1, wherein the active device comprises a vehicle aperture.

15. The steering wheel of claim 1, wherein the active device comprises a vehicle lighting system.

16. The steering wheel of claim 1, wherein the active device comprises a communication interface.

17. The steering wheel of claim 1, wherein the interface image is indicative of a control function facilitated by the at least one control interface.

18. The steering wheel of claim 1, wherein the interface image associated with each vehicle device is stored in the memory storage device, and is retrieved from memory when a vehicle device is activated.

19. The steering wheel of claim 1, wherein the device controller is configured for receiving information from an operator indicative of an operator input configured to activate a particular vehicle device and to configure the at least one control interface for inputs facilitating control over the active device.

20. The steering wheel of claim 1, wherein the interface image is formed to represent the active device and operator preferences associated with the active device and stored in the memory storage device.
